(19) United States
(12) Patent Application Publication
(10) Pub. No.: US 2019/0005139 A1
(43) Pub. Date: Jan. 3, 2019

(54) Content aggregation, presentation and related system

(71) Applicant: Ford Media, Inc., Nashville, TN (US)

(72) Inventors: Daniel Robert Ford, Nashville, TN (US); Zachary Lewis Ford, North Hollywood, CA (US)

(73) Assignee: Ford Media, Inc., Nashville, TN (US)

(21) Appl. No.: 15/932,924

(22) Filed: May 22, 2018

Related U.S. Application Data
(60) Provisional application No. 62/603,626, filed on Jun. 5, 2017.

(51) Int. Cl. G06F 17/30; G06F 3/0484

(52) U.S. Cl. CPC G06F 17/30867; G06F 17/30991; G06F 17/30946; G06F 17/30979; G06F 3/0484

(57) ABSTRACT

The present invention is generally directed to content aggregation, presentation of the aggregated content and systems related to the content aggregation and presentation. In one case, the present invention is directed to a method of aggregating content. The method comprises the steps of: receiving, by one or more processors, a request to transmit primary content created by or related to one or more sources, wherein the primary content comprises one or more of the following content types—home content, music content, video content, show content, message content, image content, social content and sponsor content; transmitting, by one or more processors, the requested primary content; organizing the primary content into more than one page, and ordering individual content items in each page based on one or more first metric values determined from previously entered data by one or more processors, for display on a graphical user interface, each of the more than one pages is directed to a single content type; presenting the organized and ordered primary content on the display of a graphical user interface for a non-transitory time; determining a value for one or more second metrics associated with the organized and ordered primary content by one or more processors; automatically transmitting, organizing and ordering, by the one or more processors, secondary content based on the value for one or more second metrics, for display on the graphical user interface, by one or more processors; thereby aggregating the content.

### FIELD OF THE INVENTION

The present invention is generally directed to content aggregation, presentation of the aggregated content and systems related to the content aggregation and presentation.

### BACKGROUND OF THE INVENTION

There have been reports of certain types of content aggregation and its display. For instance, U.S. Pat. No. 9,641,881, which is entitled “Aggregation System for Generating and Providing an Enriched Program Schedule for Media Content” is allegedly directed to the following: “A device may receive, from a source device, first information relating to programs provided by a media content service provider. The programs may include media content. The device may generate a program schedule based on the first information. The program schedule may identify a program. The device may publish the program schedule for enrichment using second information that is different from the first information, and may receive the second information based on publishing the program schedule. The second information may include information aggregated from external source devices that are different from the source device. The device may generate an enriched program schedule using the program schedule and the second information.” Abstract.

U.S. Pat. No. 9,361,373, which is entitled “Content Aggregation and Presentation” supposedly discusses the following: “Techniques for providing personalized presentations of aggregated content items are described herein. These techniques may aggregate individual content items from multiple sources, filter the content items based on the preferences of a user, and create an ordered presentation of the content items. A different presentation may be available to the user at different times, for example, a new presentation may be available each day. The new presentation may include more recent or more relevant content items than previous presentations of content items. Each presentation may combine the multiple individual content items together in such a way that each individual content item appears to the user as part of a single content item. User interaction with the aggregation of content items may be analyzed and that analysis may be used to modify subsequent selection and ordering of content items in future presentations.” Abstract.

U.S. Pat. No. 8,996,654, entitled “Aggregator with Managed Content” reportedly provides the following: “Apparatus, method, and manufacture, illustratively the aggregation apparatus connects to a sites on the Internet, authenticates itself with the sites, and facilitates at least one of: retrieving user-selected information from the sites, parsing the user-selected information from the sites to produce an aggregation, and rendering at least some of the aggregation as the output; retrieving information from the sites, parsing the information from the sites, and user-selectedly filtering the parsed information in producing an aggregation of the parsed information in producing an aggregation, and rendering at least some of the aggregation as the output; and retrieving information from the sites, parsing the information from the sites, producing an aggregation of the parsed information so as to produce an aggregation of the parsed information, and user-selectedly rendering the aggregation as the output. The rendering can include supplying content from one of the sites to another of the sites.” Abstract.

Despite reports of certain types of aggregation and display, there is still a need in the art for novel content aggregation, presentation and related systems.

### SUMMARY OF THE INVENTION

In one case, the present invention is directed to a method of aggregating content. The method comprises the steps of: receiving, by one or more processors, a request to transmit primary content created by or related to one or more sources, wherein the primary content comprises one or more of the following content types—home content, music content, video content, show content, message content, image content, social content and sponsor content; transmitting, by one or more processors, the requested primary content; organizing the primary content into more than one page, and ordering individual content items in each page based on one or more first metric values determined from previously entered data by one or more processors, for display on a graphical user interface, each of the more than one pages is directed to a single content type; presenting the organized and ordered primary content on the display of a graphical user interface for a non-transitory time; determining a value for one or more second metrics associated with the organized and ordered primary content by one or more processors; automatically transmitting, organizing and ordering, by the one or more processors, secondary content based on the value for one or more second metrics, for display on the graphical user interface, by one or more processors; thereby aggregating the content.

In another case, the present invention is directed to a non-transitory computer-readable medium which has instructions stored on it. When the stored instructions are executed by a process, the following steps are executed: receiving a request to transmit primary content created by or related to one or more sources, wherein the primary content comprises one or more of the following content types—home content, music content, video content, show content, message content, image content, social content and sponsor content; transmitting the requested primary content; organizing the primary content into more than one page, and ordering individual content items in each page based on one or more first metric values determined from previously entered data display on a graphical user interface, each of the more than one pages is directed to a single content type; presenting the organized and ordered primary content on the display of a graphical user interface for a non-transitory time; determining a value for one or more second metrics associated with the organized and ordered primary content; automatically transmitting, organizing and ordering secondary content based on the value for one or more second metrics, for display on the graphical user interface.

In still another case, the present invention is directed to a computer-implemented method for aggregating content and displaying the content in a graphical user interface. The method comprises the steps of: displaying a first window in a graphical user interface comprising a dialog box that is capable of receiving a request to transmit primary content created by or related to one or more sources, wherein the primary content comprises one or more of the following content types—home content, music content, video content, show content, message content, image content, social content and sponsor content; displaying a second window in the graphical user interface that presents the primary content in an organized fashion, wherein the content is organized based on one or more first metric values determined from previously entered data related to one or more user preferences; determining a value for one or more second metrics associated with the organized and ordered primary content by one or more processors; automatically transmitting, organizing and ordering, by the one or more processors, secondary content based on the value for one or more second metrics; displaying a third window in the graphical user interface that presents the organized secondary content; thereby aggregating and displaying the content on the graphical user interface.

### BRIEF DESCRIPTION OF THE DRAWINGS

FIG. 1 is a high-level master flow chart showing how various elements interact with each other.

FIG. 2 is a high-level software flow of use chart.

FIG. 3 shows a flow chart directed to Application Initialization.

FIG. 4 shows a flow chart directed to Data Request Cycle.

FIG. 5 shows a flow chart directed to Content Aggregation Logic.

FIG. 6 shows a flow chart directed to Presentation Logic.

FIG. 7 shows the opening screen, login screen and homepage of an application that aggregates and presents content.

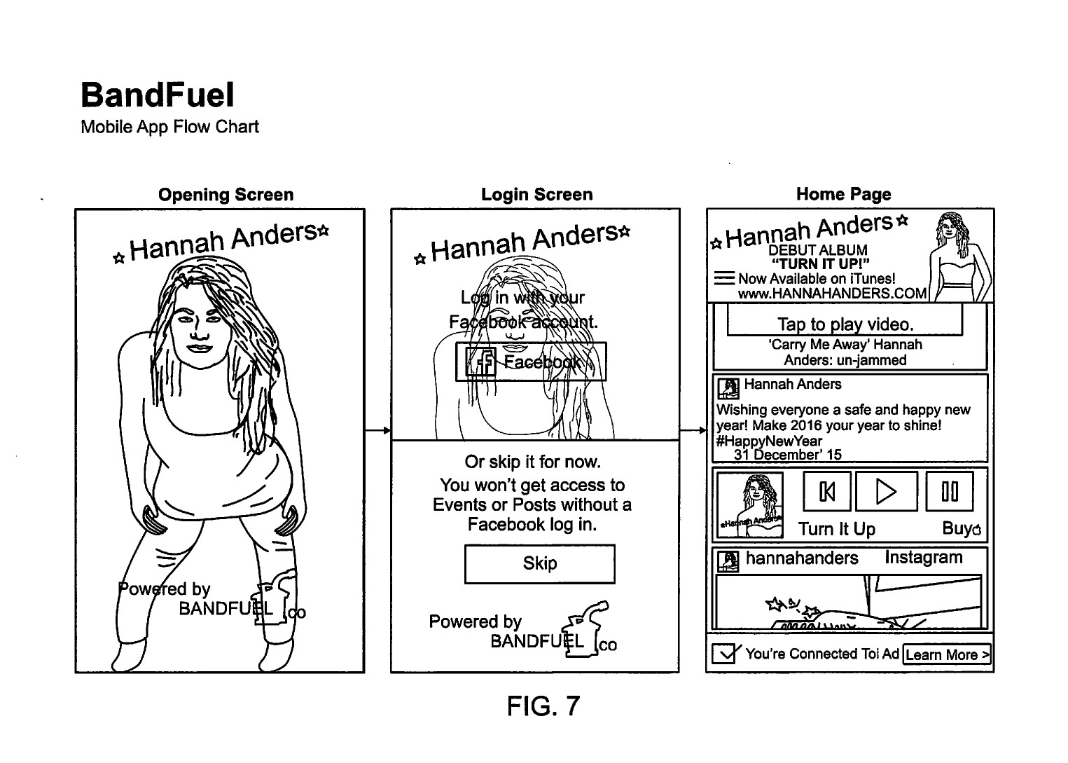

FIG. 8 shows the homepage and various elements of an application that aggregates and presents content.

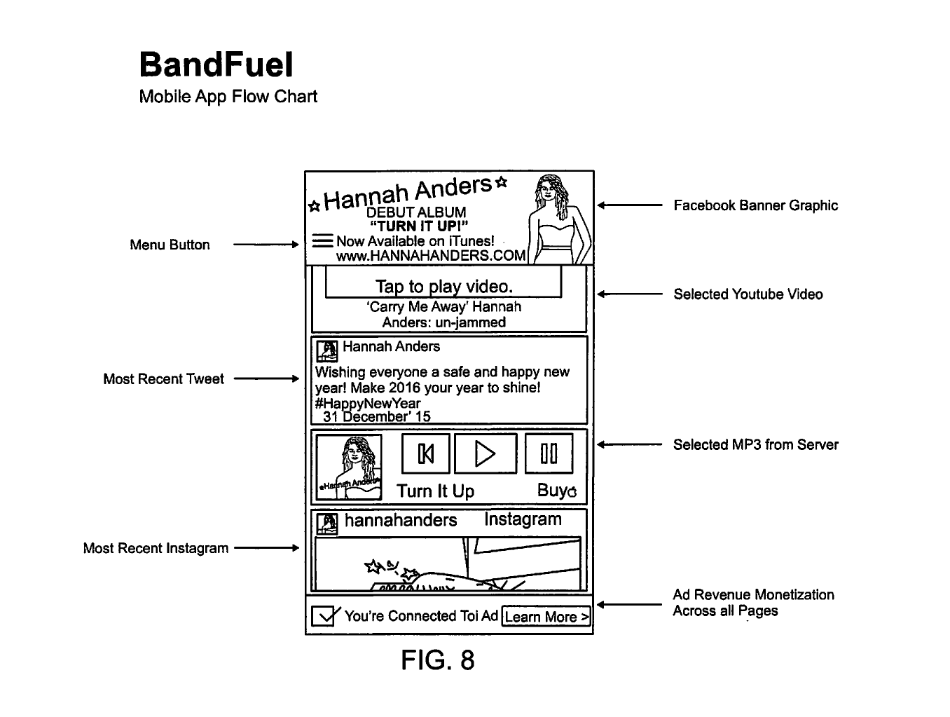

FIG. 9 shows the transition from the homepage to login/logout of an application that aggregates and presents content.

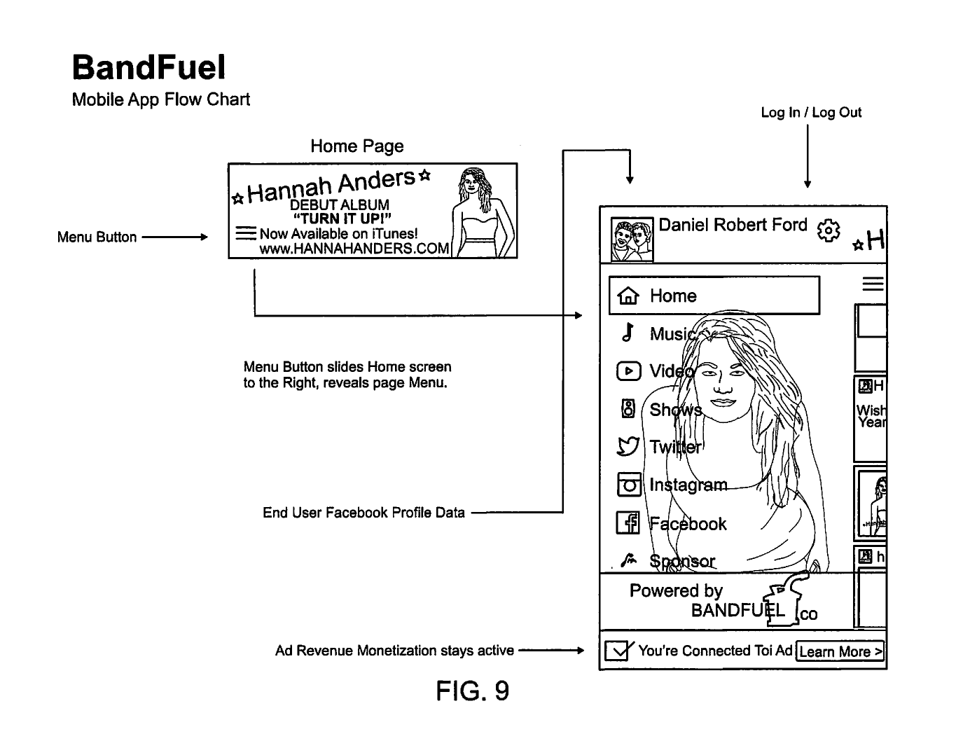

FIG. 10 shows the transition from the menu to the music page of an application that aggregates and presents content.

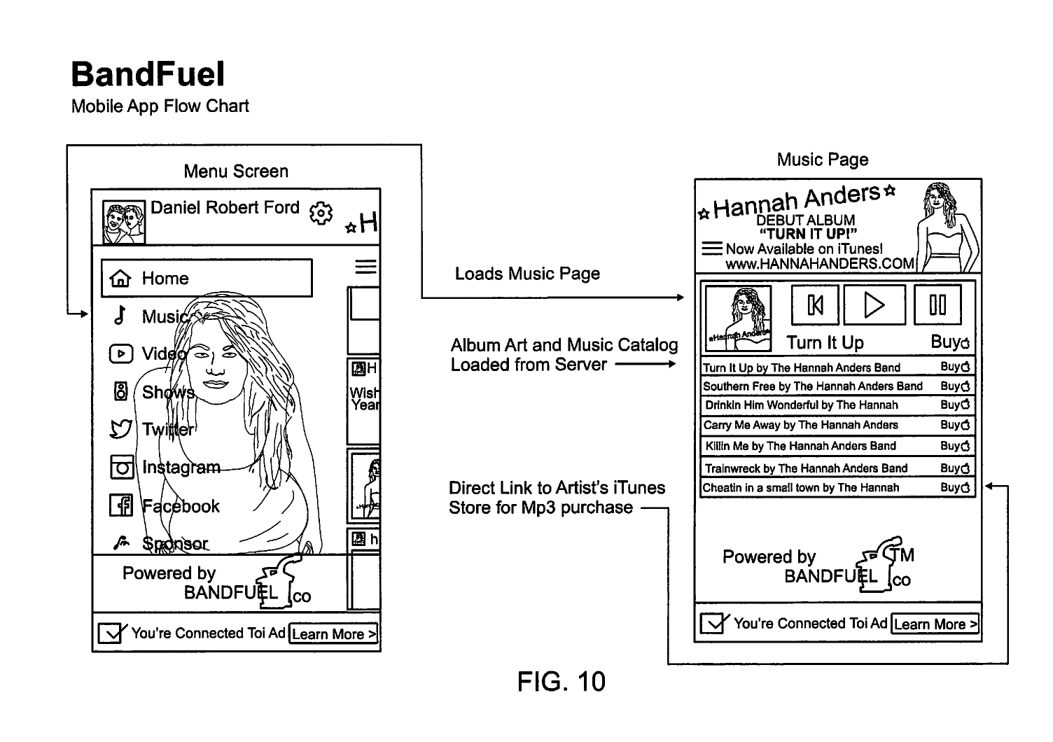

FIG. 11 shows the transition from the menu to the video page of an application that aggregates and presents content.

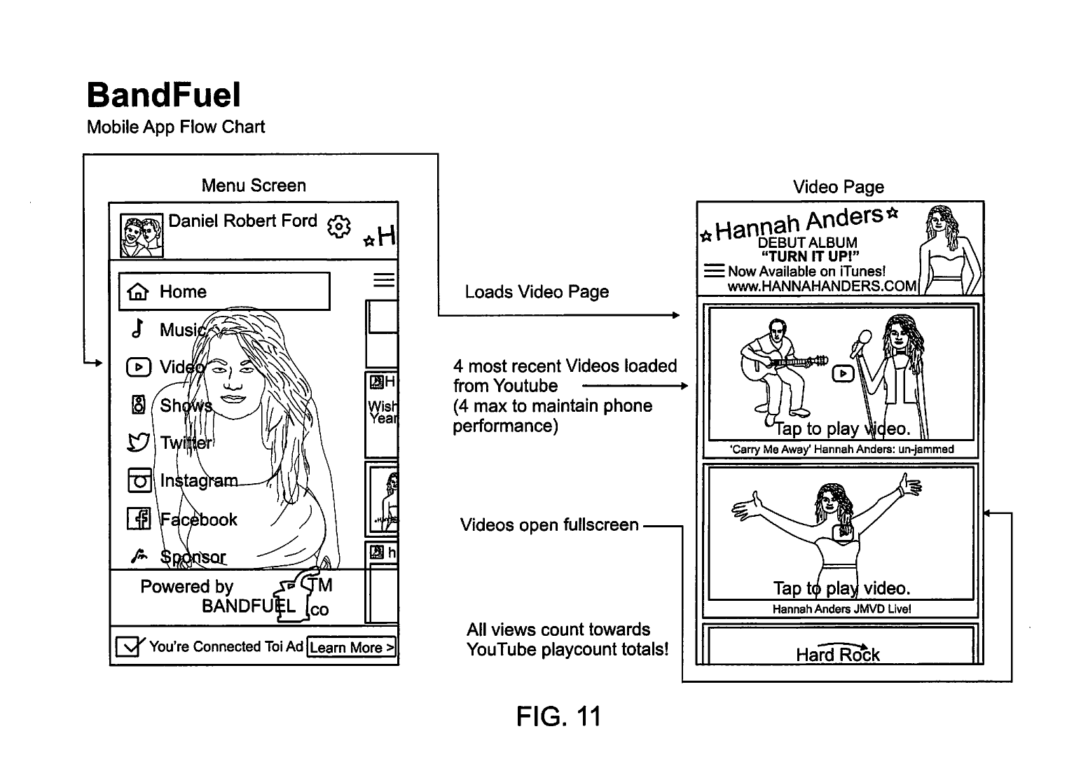

FIG. 12 shows the transition from the menu to the shows page of an application that aggregates and presents content.

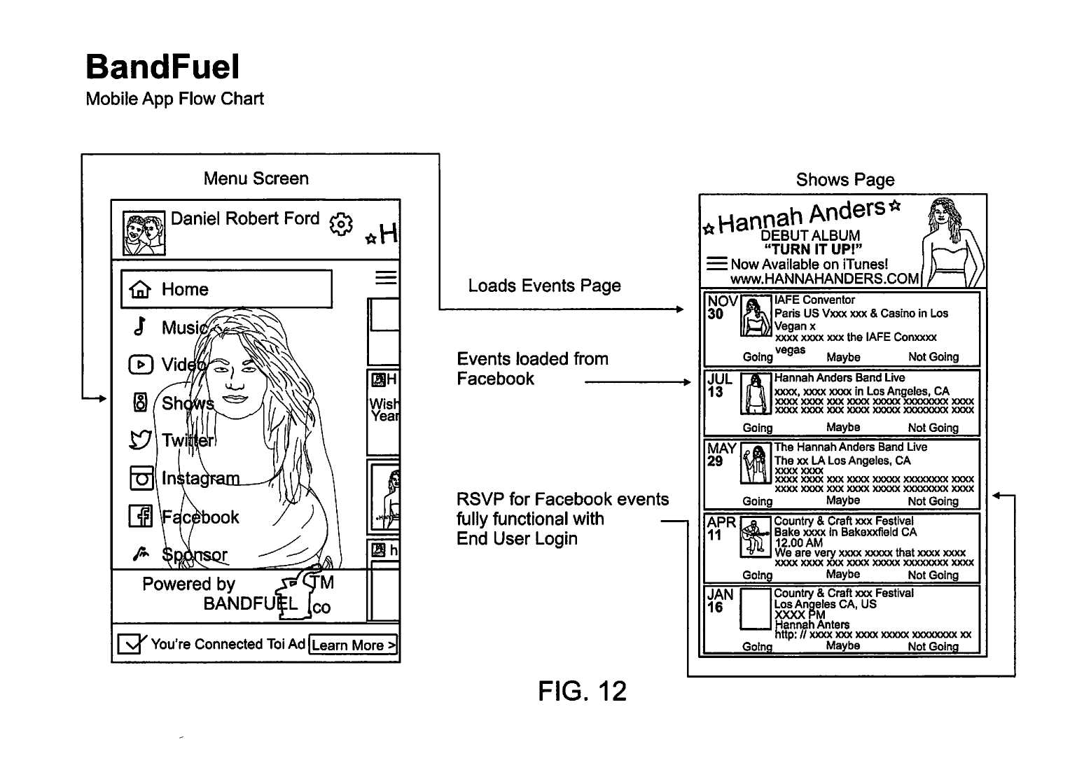

FIG. 13 shows the transition from the menu to the Twitter page of an application that aggregates and presents content.

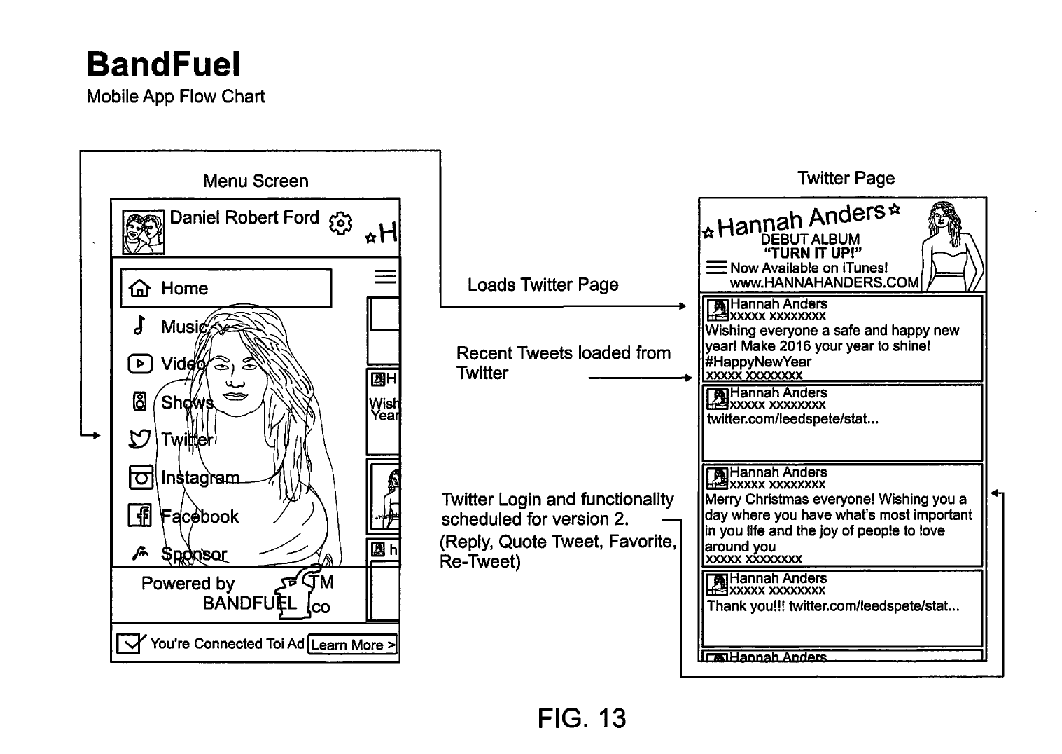

FIG. 14 shows the transition from the menu to the Instagram page of an application that aggregates and presents content.

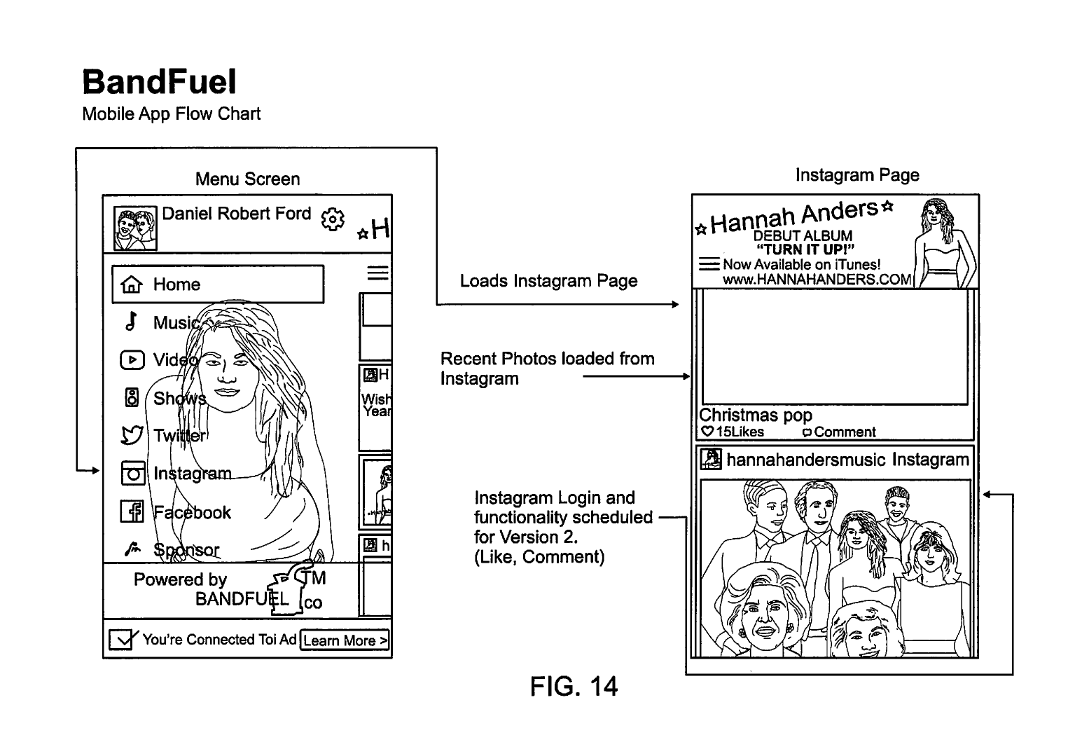

FIG. 15 shows the transition from the menu to the Facebook page of an application that aggregates and presents content.

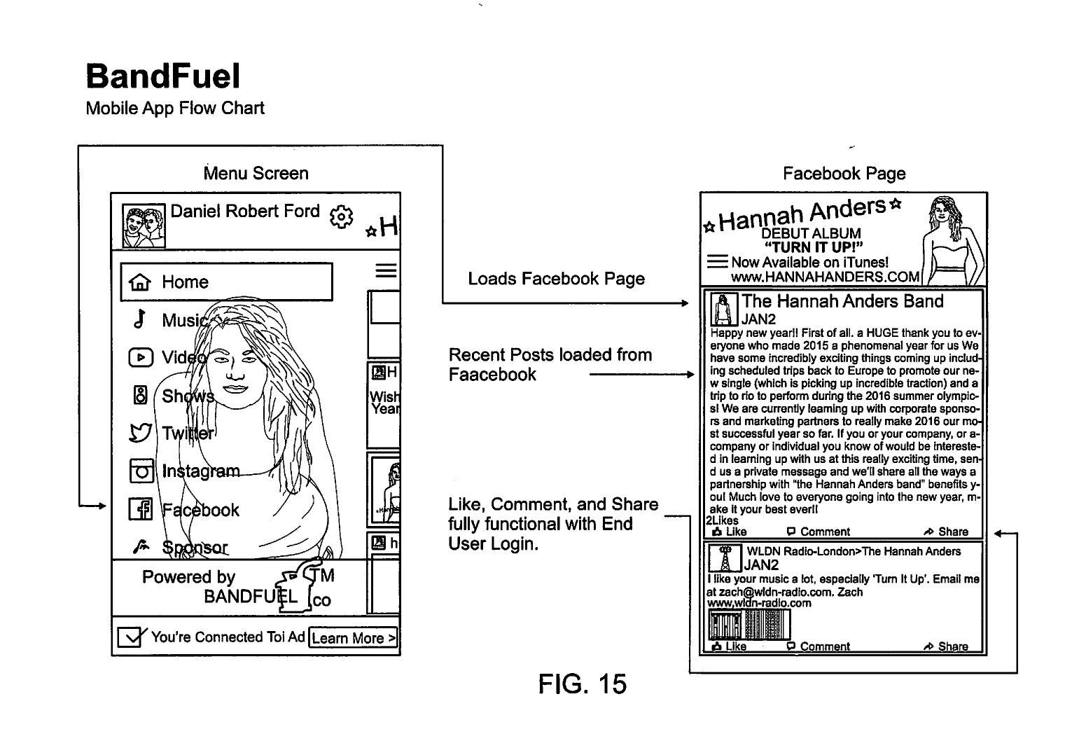

FIG. 16 shows the transition from the menu to the Sponsor page of an application that aggregates and presents content.

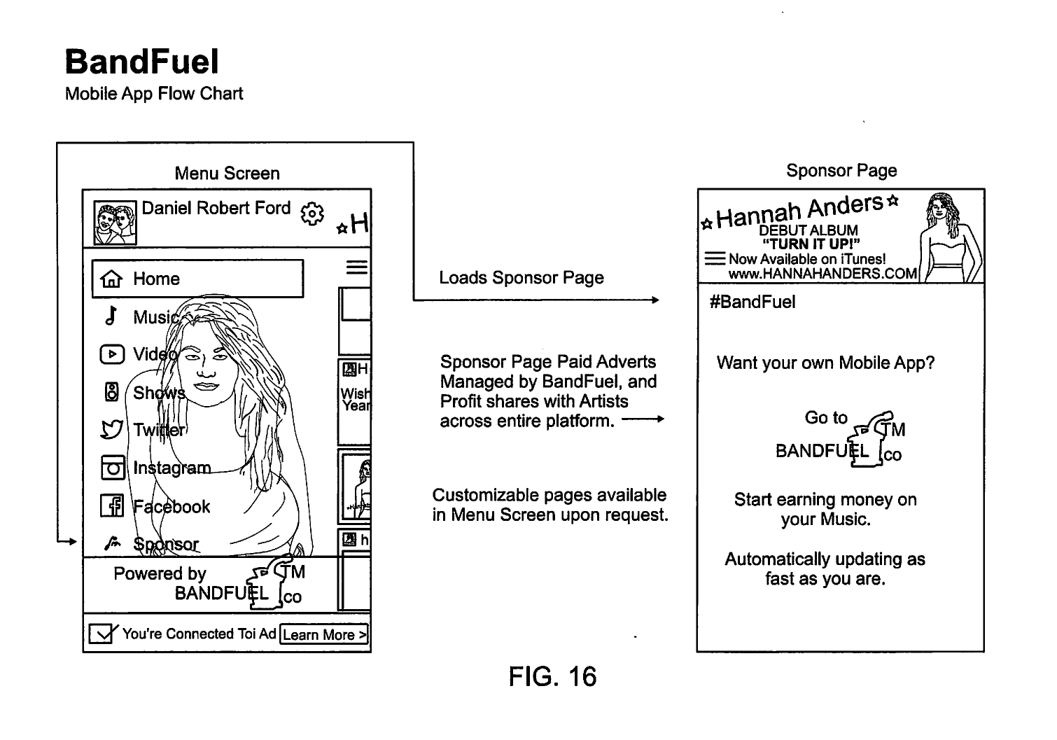

### DETAILED DESCRIPTION OF THE INVENTION

The present invention is generally directed to content aggregation, presentation of the aggregated content and systems related to the content aggregation and presentation. It is more specifically directed to a content aggregation system—and related methods and graphical user interfaces—that compiles and distributes online closed, social and network internet transmittable media including, but not limited to, data, audio, images, video and text. The content aggregation system uses, for example, mobile applications and web browsers to present relevant information to an end user.

In one case, the present invention is directed to a computer software system comprising mobile and web applications and supporting servers that use behavior-controlled aggregation and presentation logic to dynamically load and display network or internet-transmittable media. Oftentimes, the application acts as an information and media hub, providing an end user with reminders and including an ability to link outside the applications. In certain cases, the system is composed of three parts: the end-user application; the system's own web and database servers; and, third party or extended-network web servers that include the use of third party Application Protocol Interfaces (i.e., “APIs”).

The end-user application may be a software program designed to be run on iOS and/or Android operating system compatible electronic devices. The application can furthermore run on any electronic device or personal computer that can run web browsing software that supports current HTML standards and has access to the internet through network interfaces—e.g., local networks, wireless networks, Bluetooth connections and cellular networks. The system's web and database servers are typically internet-accessible and communicate with one or more end-user applications to: process end-user log-in and session management; transmit data and media that is hosted by the system's web and database servers to the end-user application; transmit data and media received from third party servers and APIs to the end-user application; collect and store metrics relating to the end-user's use of the end-user application and personal information about the end-user as it is made available to the system.

The media loaded and presented by the software includes, but is not limited to, encoded data, audio, images, video and text. Data and media are hosted and served by servers run as part of the software system and by external, third party servers such as Facebook, Twitter, Instagram and YouTube. The content aggregation system uses behavior-controlled algorithms dynamically to aggregate data, information and media that is loaded into the end-user application. As additional data, information and media are loaded, the algorithms take the new information into account to dynamically respond to user interaction with the end-user application and data received from the system's servers and extended network servers.

The aggregation logic and algorithms take input from data sources such as the system's own web and database servers and extended-network servers. Nonlimiting examples of input forms used by the aggregation logic and algorithms include content data and media, control data, and user metric data. The aggregation logic and algorithms operate on the input using methods to optimize, organize, and structure the input for maximal or designed effect. Input treatment methods include, for example, techniques to assess the following: user behavior; collected user metrics; available input; control variables provided by the system; the device/machine/computer architecture on which the system is operating. The aggregation logic and algorithms produce output in the form of a refined set of the input.

Presentation logic and algorithms take input such as the output of the aggregation logic and assessment of the device/machine/computer architecture on which the system is operating. The presentation logic and algorithms operate on the input using methods to prepare and organize, load and render the input for display and presentation to the user for designed effect. Output in the form of the end-user application's user interface and the audial, graphical and interactive elements that are presented to the end-user therein are produced by the presentation logic. The presentation logic receives further input which is interaction from the end-user with the end-user application's user interface and uses this input to further inform the presentation and aggregation algorithms and to collect and store user metric data.

### Definitions

“Application” refers to the computer software application that is stored and run on a mobile device, or stored on the system's web servers and run in a personal computing device's web browsing software. The application uses Display Logic and has a GUI that is presented for interaction by the End-User. The application also includes Data Aggregation Logic, Business Logic, local Data Storage, Data Communication logic, and Asset Management logic. The application interacts with the platform's Network Adapter to send and receive data and media through available networks. The Application is managed by a Document Class which handles instantiation, management, usage of the supporting/management classes or libraries of code.

“Application Databases” refers to the set of databases used by the Application Servers for data and media storage that relate to incarnations of the Application.

“Application Incarnation” refers to a version of the Application that is controlled by configuration, both pre-set and dynamic, to focus on a subset of available media and data. An example of this is an Application Incarnation for a band, where the band's social networks and media are used as the primary, but not sole, source of data and media that is aggregated by the system and delivered to users running this Incarnation. The GUI may be themed for a specific Incarnation.

“Application Servers” refer to the set of servers that are used by the system to run scripts, host data and media and make these items accessible over the internet or other networks. The Application Servers use Application Databases and other Data Sources to store and retrieve data and media that is sent to the Application through the Network Adapter being used.

“Asset Management” refers to the set of logic used by the Business Logic to retrieve, store, and manage audio, visual, and other types of media assets.

“Business Logic” refers to the set of logic and algorithms instructed by the GUI and the Application code to manage the state of the Application. The business logic manages the GUI's state, uses Data Aggregation Logic to assemble data and media from a variety of sources, and interacts with local Data Storage, Asset Management logic, and Data Communication logic to retrieve data and media from sources local and external to the application. When the Application has loaded and the user's account logged in and the user's session begun, the Business Logic directs the loading of an initial data set. This initial data set incorporates data pertaining to what content should be shown and any relevant data that the Data Aggregation Logic will need to perform its intended functions. The Business Logic then directs the Data Aggregation Logic, Data Storage, Asset Management Logic and the Data Communication Logic to load all relevant content (images, text, other media, etc.). As the initial data set and future requests for data and content return to the Application, the Business Logic responds by directing the GUI to update the Application's display.

“Constructs Management Classes” include: Constants, Sound Manager, Data Communication (Server Connection), Data Storage (Data Service), Asset Manager, Dialog Controller, Display Logic, Data Aggregation Logic.

“Constructs Screen Classes” (constitute Business Logic) include: Title, Error, Main Screen, Menu Screen, Login. Screens represent states of the application. This manages platform and device specific data and functionality and acts as an interface to plugins including platform specific plugins.

“Data Aggregation Logic” refers to the set of logic and algorithms used by the Business Logic to determine how the loaded media will be arranged for presentation to the End-User via the GUI. The Data Aggregation algorithms use configuration variables, perform analyses of the media that may be presented, perform analyses of the collected user data metrics and make determinations about how the data and media should be assembled.

“Data Communication” refers to the logic used to send and receive data for use by the Business Logic and for possible short-term or long-term storage by the Data Storage logic. The Data Communication logic interacts with the network adapter provided by the platform on which the Application is operated.

“Data Sources” refers to the set of servers and other data sources that provide data and media to the Application Servers and to the Application through the Network Adapter being used.

“Data Storage” refers to the logic and memory used to store data locally for the duration of single or multiple operations of the application. Data is stored and retrieved by the Business Logic and the Data Communication logic.

“Display Logic” refers to the set of logic and algorithms used by the GUI to determine how to present information and media to the End-User, utilizing the application on a given mobile device or web browser. The Display Logic is the set of routines and algorithms that control how information and assets are arranged on screen. When the Application is initialized the Display Logic code is instantiated. At this time the environment or platform the Application is operating on is assessed. The platform and device are noted and stored for the duration of execution, and some of this data is sent for collection to the Data Aggregation logic to be collected with user metrics. If the environment is a PC web browser, the available browser screen resolution is noted. If the environment is a mobile platform (such as iOS or Android), the available screen resolution is noted along with any determinations that can be made about which hardware device is being used and which version of operating system is present. At the time the Application requests for the GUI to display pages and content for these pages, the Display Logic determines if and which art assets need to be resized to cover the desired area of the available screen resolution, and this is performed prior to the assets being rendered to the display. Background art assets, title and cover assets, header and footer elements all get resized to fill available display area. Driven content elements get resized and/or repositioned for optimal visual arrangement, and optimal use of the device the Application is being run on.

“Document Class” refers to base class instantiated upon application being launched.

“End-User” refers to the entity operating the computer software and interacting with the application's graphical user interface (i.e., “GUI”). The End-User interacts with the mobile device's operating system in order to launch the application, and the End-user interacts with the GUI that is presented by the application.

“Graphical User Interface” or “GUI” refers to an interface provided by the application for the purpose of interaction with the End-User. The GUI uses Display Logic to determine how to be presented, passes data resulting from user interaction to the Business Logic and receives instructions for its behavior from the Business Logic. The GUI code is responsible for managing assets in use for the current display. The Graphical User Interface consists of text elements and art assets. The art assets come from multiple sources: those distributed and installed as a part of the application, those provided by the Application's servers, and those provided by extended network data providers such as social networks. Some art assets and some text assets are used to operate as buttons for the end user to interact with. In response to interaction with these buttons the state of the application will change, including but not limited to controlling the position of GUI elements on the screen, triggering a request for more data to be retrieved and displayed, playing and stopping audio and video assets, and linking outside the application such as to a web page loaded into the device's web browser or other device specific applications.

“Mobile Device/Web Browser” refers to the computer platform on which the end-user application runs. This represents, but is not limited to a mobile device and its operating system or a personal computing device and its web browsing software.

“Network Adapter” refers to the network interfaces and related elements provided by the mobile device operating system or utilized by the web browsing software that is running the application. The network elements interacted with the Data Communication Logic and the Asset Management logic. The Network Adapter communicates with the system's Application Servers and other Data Sources.

Overall Computer Architecture

An End-User application (a computer software application) may be run on mobile or personal computer machines. In one case, the End-User application is run on iOS mobile phones and tablets. In another case, the End-User application is run on Android-compatible mobile phones, tablets and other devices (e.g., Kindle Fire). In still another case, End-User application is run through a web browser on machines and devices, including mobile device web browsers and desktop or laptop personal computers, where the web browser is compatible with most current HTML standards. In all cases the device or personal computer will have access to the internet so that the End-User application will function properly. Access to the internet can occur through network interfaces supported by the device/PC, including but not limited to local networks, wireless networks, Bluetooth connections and cellular networks.

Application Servers and Application databases are operated to deliver End-User application data and media and are typically accessible through the internet. One or more internet web servers that are capable of hosting and serving standard HTML files and server scripts—such as PHP scripts—can be used, for example, to accomplish the following: provide two-way communication between the End-User application and the back-end business logic; host and serve the web-browser compatible incarnation of the End-User application; host and serve management and configuration tools used to control the behavior of the End-User applications. The back-end logic of the system is hosted on the web server; management and configuration tools are a set of configuration scripts that allow configuration of system variables and management and editing of media and data storage. A Database Server can be used by the back-end Business Logic for data storage and retrieval.

One or more Content and Configuration Servers are used by the back-end Business Logic for storage and delivery of: End-User application content (i.e., content comprising data and media); back-end Business Logic; End-User application and presentation logic and algorithm configuration. One or more Music Asset Content Delivery Server are used by back-end logic for the storage and delivery of graphic assets to the End-User application. External Servers (i.e., Data Sources) or Extended Network Servers are operated by third parties and support the system by providing means of distributing the End-User application and/or providing information in the form of data and other types of media assets. Information and media are obtained through public channels and/or through APIs provided by the operators of the servers. The set of Extended Network Servers may include, without limitation, the following:
1. iTunes Server—used for End-User application distribution on iOS compatible devices and machines and as a link-out destination for items distributed by the iTunes server such as applications, audio files and e-books;
2. Google Play Server—used for End-User application distribution on Android compatible devices and machines and as a link-out destination for items distributed by the Google Play Server such as applications, audio files and e-books;
3. Apple iAd Server—used for serving media to End-User applications on iOS compatible devices and machines;
4. Google Ads Server—used for serving media to End-User applications on Android compatible devices and machines;
5. External Music Asset Content Deliver Server—used to provide audio assets and data relating to these assets;
6. External Art Asset Content Delivery Server—used to provide graphic assets and data related to the assets;
7. External Video Asset Content Delivery Server—used to provide video assets and data related to the assets;
8. Facebook Graph Server—used to provide End-User application and the back-end business logic interaction with Facebook APIs, which serve Facebook-related data and media assets;
9. YouTube Server—used to provide the End-User application and the back-end Business Logic interaction with the YouTube APIs, which serve YouTube-related data and media assets;
10. Instagram Server—used to provide the End-User application and the back-end Business Logic interaction with the Instagram APIs, which serve Instagram-related data and media assets;
11. Twitter Server—used to provide the End-User application and the back-end Business Logic interaction with the Twitter APIs, which serve Twitter-related data and media assets.

High-Level Master Flow Chart

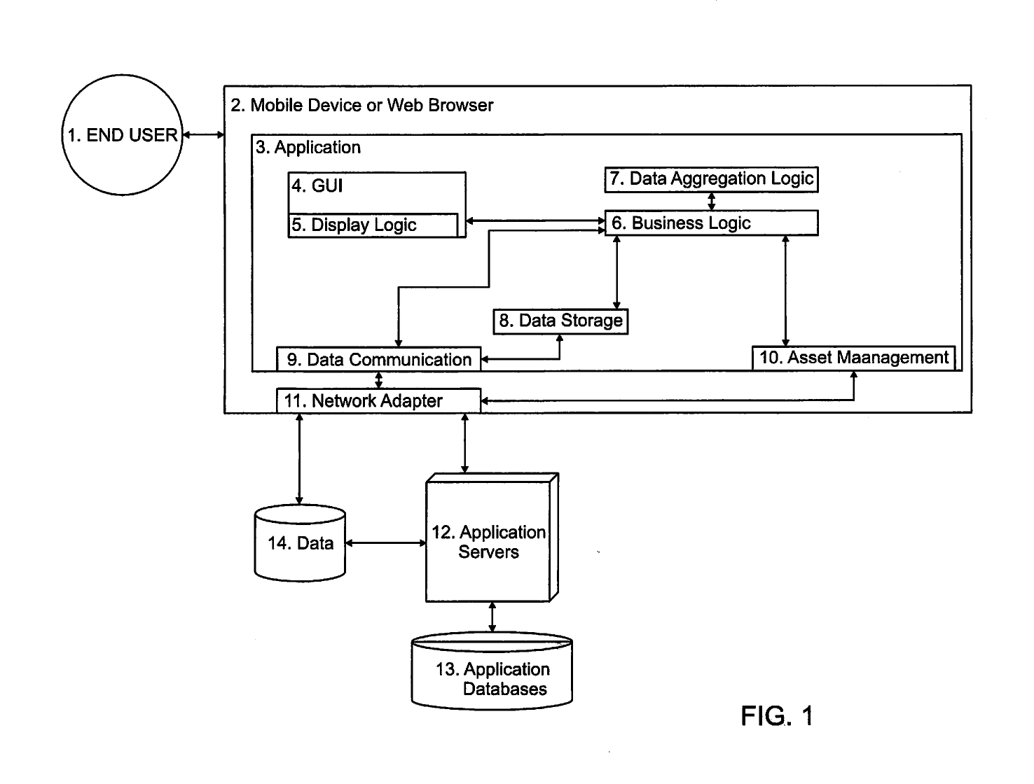

A summary of FIG. 1 and the relationship among presented elements is discussed below. Elements interact with each other as shown by the arrows in FIG. 1 and as noted below. In some cases, two or more elements may have a relationship that can be described as one element being used by another or as one element being owned by another, as indicated in FIG. 1 and as follows: 1—End User (2,4); 2—Mobile Device/Web Browser; 3—Application (4,5 on 2, has 4-10); 4—GUI (5,6 of 3); 5—Display Logic (used by 4); 6—Business Logic (4,7,8, 9, 10); 7—Data Aggregation Logic (used by 6); 8—Data Storage (6,9); 9—Data Communication (6, 8, 11); 10—Asset Management (6, 11); 11—Network Adapter (9, 10, 12, 14); 12—Application Server (11, 13, 14); 13—Data Sources (11, 12).

Description of FIG. 1

The entity operating the computer software and interacting with the application's GUI is the End-User. The End-User interacts with the mobile device's operating system to launch the application, and the End-User interacts with the GUI presented by the application. The computing platform on which the End-User application runs is a Mobile Device/Web Browser. Nonlimiting examples of such computing platforms include a mobile device and its operating system or a personal computing device and its web browsing software. The Application is the computer software application that is stored and run on a mobile device or stored on the system's web servers and run in a personal computing device's web browsing software. The Application uses Display Logic and has a GUI that is presented for interaction by the End-User. The application also includes Data Aggregation Logic, Business Logic, local Data Storage, Data Communication logic, and Asset Management logic. The Application interacts with the platform's Network Adapter to send and receive data and media through available networks. The Graphical User Interface is provided by the Application for the purpose of interacting with the End-User. The GUI uses Display Logic to determine how to be presented, passes data resulting from user interaction to the Business Logic, and receives instructions for its behavior from the Business Logic.

High Level Flow of Use Chart

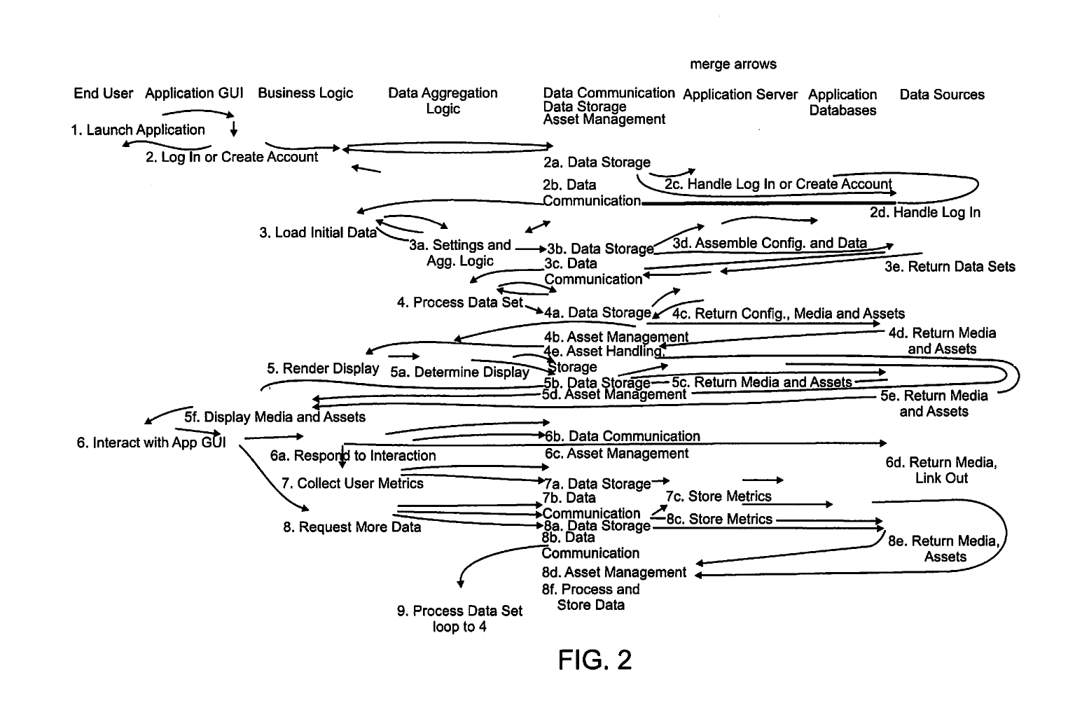

A summary of FIG. 2 and a description of the function of the presented elements is as follows: 1—End-User (Launch Application); 2—Application GUI (Log In or Create Account); 2a—Data Storage; 2b—Data Communication; 2c—Application Server (Handle Log In or Create Account); 2d—Data Sources (Handle Log In); 3—Business Logic (Load Initial Data); 3a—Data Aggregation Logic (Settings and Agg. Logic); 3b—Data Storage; 3c—Data Communication; 3d—Application Server (Assemble Config. and Data); 3e—Data Sources (Return Data Sets); 4—Data Aggregation Logic (Process Data Set); 4a—Data Storage; 4b—Asset Management; 4c—Application Server (Return Config., Media and Assets); 4d—Data Sources (Return Media and Assets); 4e—Asset Management (Asset Handling, Storage); 5—Business Logic (Render Display); 5a—Data Aggregation Logic (Determine Display); 5b—Data Storage; 5c—Application Server (Return Media and Assets); 5d—Asset Management; 5e—Data Sources (Return Media and Assets); 5f—Application GUI (Display Media and Assets); 6—End-User (Interact with App GUI); 6a—Business Logic (Response to Interaction); 6b—Data Communication; 6c—Asset Management; 6d—Data Sources (Return Media, Link Out); 7—Business Logic (Collect User Metrics); 7a—Data Storage; 7b—Data Communication; 7c—Application Server (Store Metrics); 8—Business Logic (Request More Data); 8a—Data Storage; 8b—Data Communication; 8c—Application Server (Store Metrics).

After being launched (1) the Application determines if it can log in using an existing account (2a) or else it prompts the user for new or extended network user account credentials. The Application sends new or existing log in credentials (2b) to one or more of the Application Server and external Data Sources. The Application Server handles the user account log in or creates a new user account in the Application Database (2c), and external Data Sources confirm or deny (2d) the successful use of user account credentials. If the log in fails, or there is an error, the Application will return its state to the Log In or Create Account screens (2). If the log in is successful, the Application loads an initial set of data that will determine what information and media is available (3) using settings and configuration information (3a) and may store user credentials and other data locally (3b). In order to load the initial set of data, the Application sends requests for data and media (3c) to the Application Server for user-related information (3d), which may retrieve media assets from external Data Sources, and to external Data Sources to determine what information and media is available (3e).

All loaded data and media is processed (4) and stored locally along with the results of data analysis (4a). The Data Aggregation Logic (4) determines what additional media should be loaded and instructs the Asset Management Logic to retrieve these assets (4b). Control is then handed to the Business Logic (5) while media assets are retrieved asynchronously. The Application Server transmits data and media (4c) back to the Application. External Data Sources transmit data and media (4d) back to the Application. All loaded data and media is stored locally (4e).

Upon receiving loaded data and media, the Business Logic renders or updates the Graphical User Interface (5). To render the GUI, the Data Aggregation logic uses algorithms to determine what information and media will be presented (5a). Information that is already available (5b) is used to render the initial views of the GM (50. The Asset Management logic is instructed to load media assets (5d). Media assets that are hosted on the Application Server are retrieved (5c) and asynchronously the GUI is updated (50. Media and additional data assets that are hosted on external Data Sources are retrieved (5e) and asynchronously the GUI is updated (5f).

The End-User interacts with GUI elements (6). In response to some types of user interaction, the Business Logic sends data to the Application Server or external Data Sources (6b) that require no response. In response to user interaction with some types of media, including audio, video, and link outs, the Business Logic will interact with the Asset Management logic (6c) and external Data Sources (6d). In these cases of user interaction the Business Logic will collect user metric data (7) and store information locally (7a) and send information (7b) to the Application Server for storage on the back-end (7c).

In the cases of user interaction that requires additional data and media to be loaded, such as when more media is determined to be presented than the Application currently has stored information about: user metrics data is collected and stored locally (8a); the requests for more media and collected user metrics data are communicated (8b) to the Application Server where user metrics are stored (8c); and Asset Management logic retrieves media assets (8d). External Data Sources respond to requests for data and media assets (8e). All loaded data and media assets cause the application logic (80 to loop back to the Processing of incoming data sets (4), which in turn result in the GUI being rendered or updated (5).

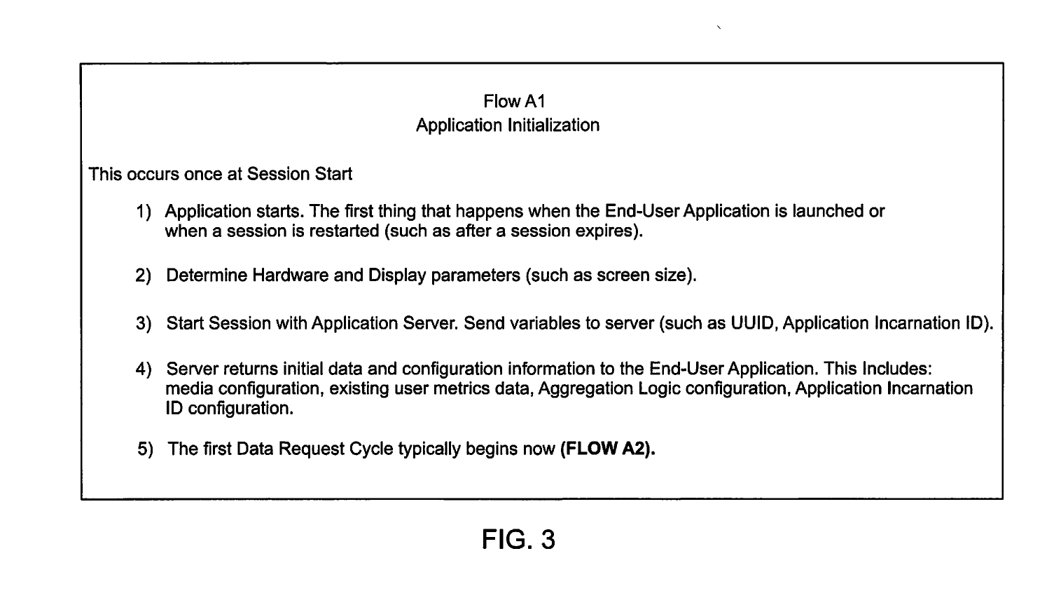

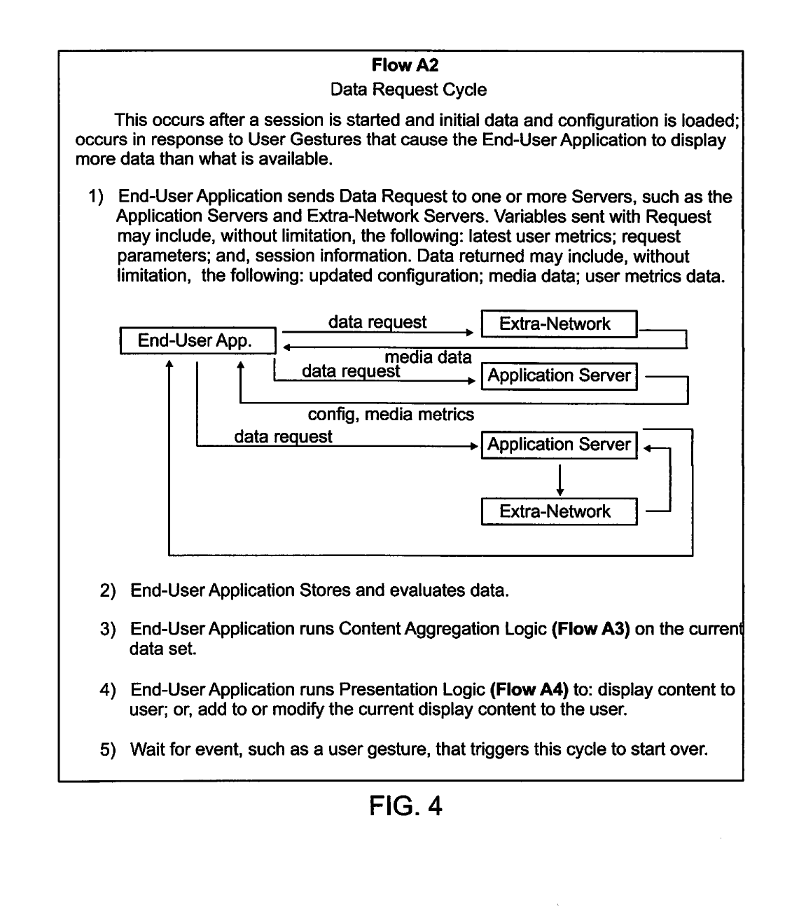

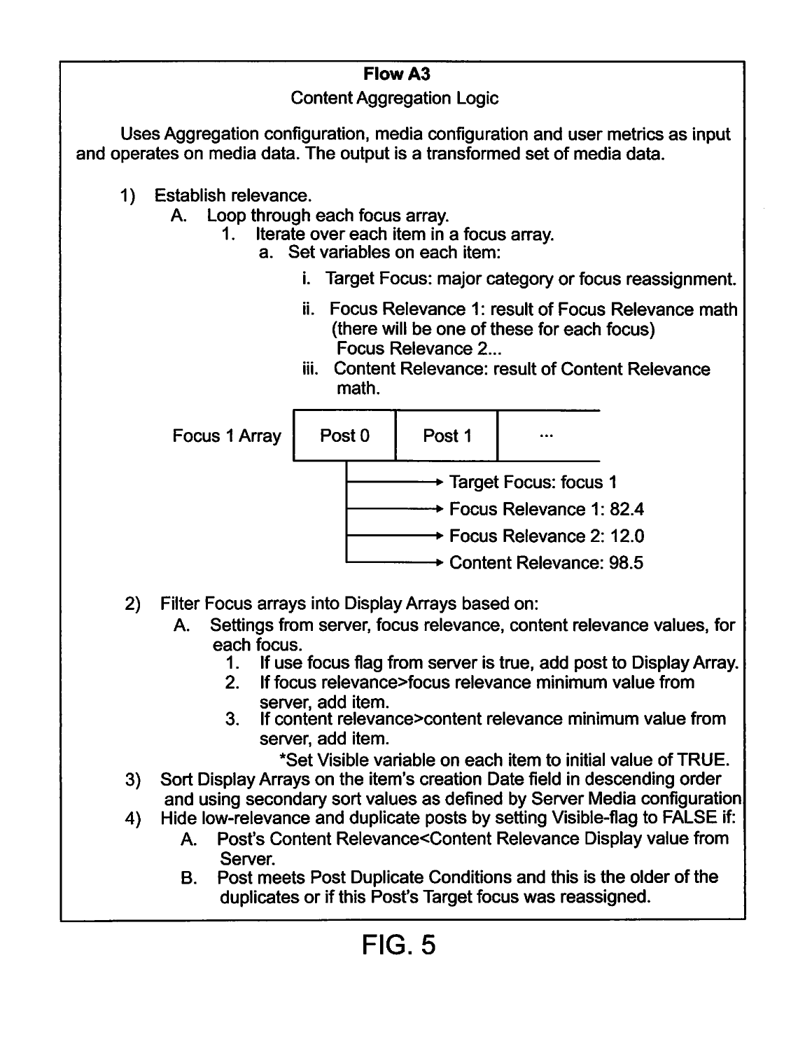

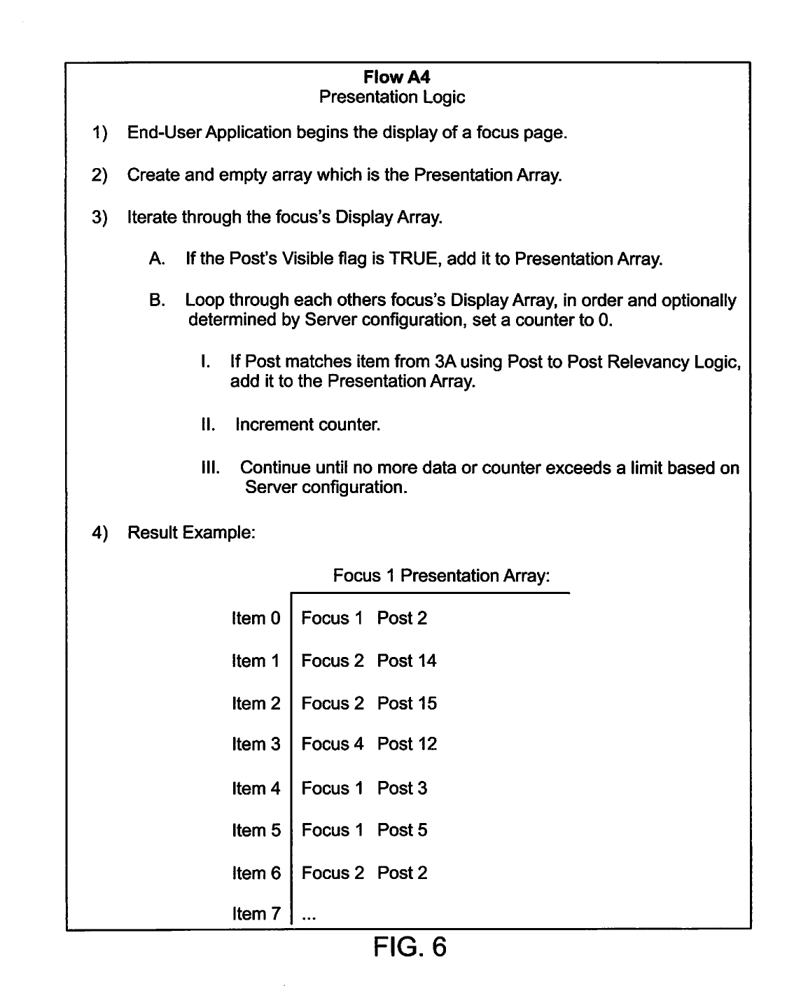

Flow charts presenting how parts of the code interact in more detail are shown in FIGS. 3-6: Flow A1, FIG. 3, is directed to Application Initialization; Flow A2, FIG. 4, is directed to Data Request Cycle; Flow A3, FIG. 5, is directed to Content Aggregation Logic; Flow A4, FIG. 6, is directed to Presentation Logic.

For each of the possible data sources, data is requested with the priority being future and most recent data, and with a volume that is a percentage (determined by Server configuration) more than is required to display one and a half screens full of data for the hardware device being used. When the user attempts to view more data than the application currently has in memory, additional data is requested from the server. The new data is added to the data currently stored in memory and the Content Aggregation Logic is used to prepare this new data for display.

The display of data and content to the end user is organized by pages. Each page contains a different subset of data and content selected by the Data Aggregation routines. A page has an established focus of content, and this focus is a primary determinant in what content will be included on this page. Nonlimiting examples of the focus of each page include:
1. Home—the first page displayed to the end user after the Application launch, startup, and log in sequences; this page focuses on a general sampling of recent data and content, and provides an interface for interacting with the content being displayed as described below.
2. Music—this page focuses on music—oriented data and content, and provides an interface for the end user to interact with audio files.
3. Video (YouTube)—this page focuses on video-oriented data and content and provides an interface for the end user to interact with video files.
4. Shows—this page focuses on live or broadcast events and provides an interface to interact with, or obtain access to an interface for interacting with, events and event-hosting websites (such as Facebook and Eventbrite).
5. Messages (Twitter)—this page focuses on Twitter-oriented data and content, and other short-form social media, and provides an interface for interacting with this short-form social media.
6. Images (Instagram)—this page focuses on image-oriented data and content, including Instagram, and provides an interface for interacting with the image through methods provided by the social media providers of the image.
7. Social (Facebook)—this page focuses on Facebook and other long-form social media and provides an interface for interacting with the content displayed through methods provided by the social media providers of the content being displayed.
8. Sponsor—this page focuses on data and content relating to Sponsors and provides an interface for interacting with the content being displayed, including but not limited to surveys and link-outs.

Access to the pages is made available in a menu GUI element. The menu GUI element will present to the user a button for each page being made available, and pressing each button will begin the process of redrawing the GUI for this new page and the process of requesting any required data, content, or media needed to display the page and its content. A subset of all Pages is displayed to the end user in the Menu GUI element. Which pages are made available to the user is determined at the conclusion of the Content Aggregation Process.

Content Aggregation Process:

As Data and Content are retrieved by the Application, they are stored in the Data Storage logic organized by the source of the content. The Content Aggregation Process is run in the following way: prior to rendering the Home page with the initial data set; continually as content is retrieved by the Application; and, before pages are rendered or updated.

The first step in the Content Aggregation Process is to iterate through all the data and content that is available to the Application. Each item in the iteration (a “post”) is examined for a variety of factors, and variables are stored for each post to track the determinations of this examination. These determinations are referred to as the relevance factors for the specific post. The following are the relevance factors that are determined:

Target Focus:

Each Post will have a Target Focus value associated with it, indicating under which Page/Focus the Post should be grouped. As each Post is examined, the Target Focus is initially set based on the Source of the Post, and the value is adjusted as the Content Aggregation Process operates.

Focus (Page) Relevance:

The relevance of each entry for each focus is set. Each post will have a set of values associated with it, noting the relevance of the post to each of the available focus/pages. To compute the relevance value of the post for each focus, facts about the post will be established, where each fact contributes a weighted value to the relevance value sum. The Application Server may provide the relative weight for each of the fact contributions; if so the value for the fact will be: ([Fact True or False Boolean as integer value 1 or 0]*100)*[Fact contribution]*(1/[server-provided weight for this fact]). If the weight for a fact is not provided by the Application Server, the value for the fact will be: ([Fact True or False Boolean as integer value 1 or 0]*100)*[Fact contribution]*(1/[total facts being established for relevance to this focus]).

Facts for Focus Relevance:
1. Does the source of the Post match with the focus? Fact contribution: 1. Ex. Post Source of Facebook matches with Social Focus. Post Source of YouTube does not match with Social Focus.
2. Including itself, are there more than zero Posts that can be considered a duplicate? This test causes this Fact Boolean to always be True. Fact contribution: 1/[including itself, total number of duplicate posts].
   In order to determine one Post as a duplicate of another at least one of the following statements must be true:
   a. Source and Focus match for both Posts, and text content is 75% or more the same, and any attached or linked media are identical between Posts.
   Ex. Both Posts have Source Facebook and we are calculating Focus Social, one Post's text is “This is a test” and the other's text is “This is a test.”, and neither Post has attached or linked media.
   b. Source and Focus do not match for both Posts, and text content is 50% or more the same, and any attached or linked media are identical between Posts.
   Ex. One Post has Source Facebook and we are calculating Focus Social and the other Post has Source Twitter, one Post's text is “This is a test” and the other's text is “This is a test too”, and each post has a link which points to the same image URL.
   c. Source and Focus do not match for both Posts, and one Post is determined to be a share of the other Post.
   Ex. One Post has Source Facebook and we are calculating Focus Social and the other Post has Source Twitter, one Post's text is “This is a test” and the other's text is “This is a test”, and the Facebook Post has flags or variables which indicate the user “posted to Twitter”.
3. Does the content of the Post match with the focus? Any media attached or linked to a Post is examined. If the media type and Post content does not match the Focus causes this Fact's test to answer false. The following aspects of the Post are looked at:
   a. Do Messages and Social focus posts have text content?
   b. Do Music focus posts have audio links or attached audio media?
   c. Do Video focus posts have video links or attached video media?
   d. Do Image focus posts have image links or attached image media?

Content (Post) Relevance:

The content relevance for each entry is set. Each post will have a Content Relevance value associated with it, noting the relevance of the post's content in a general way and to the Target Focus. To compute the relevance value of the post, facts about the post will be established where each fact contributes a weighted value to the relevance value sum. The Application Server may provide the relative weight for each of the fact contributions; if so the value for the fact will be: ([Fact True or False Boolean as integer value 1 or 0]*100)*[Fact contribution]*(1/[server—provided weight for this fact]). If the weight for a fact is not provided by the Application Server, the value for the fact will be: ([Fact True or False Boolean as integer value 1 or 0]*100)*[Fact contribution]*(1/[total facts being established for relevance]).

Facts for Content Relevance:
1. Does the post have key words in any text content, post attachments or linked media, or hashtags that relate to the Target Focus? Fact contribution: 1. Key words are provided by the Application Server in the initial data set.
2. Is the Post not shared, or if shared is it from a source or other author that relates to the Target Focus? Fact contribution: 1 if not shared, 0.75 if shared. The Other Author or source is relevant to the Target Focus if it can be associated with keywords provided by the Application Server. It can be associated if the source description, or other data that is obtained about the source, contains any of the keywords.
3. Has the user engaged with Posts in the Target Focus before? Engagement is determined by the user having liked a post, shared a post, pressed a subscribe button attached to a post, replied, retweeted, commented on, or in other ways interacted with a post. This fact is determined by user metrics that are gathered by the Application, tracked on the Application server, an provided to the Application in its initial data set. Fact contribution: 0.25 if the user has engaged less than 2 times, 0.5 if the user has engaged less than 5 times, 0.75 if the user has engaged less than 10 times, and 1 if the user has engaged 10 times or more.
4. Have other users of this Application Incarnation engaged with posts in the Target Focus before? Engagement is determined as per Fact 3 above, and this fact is determined by user metrics that are gathered by the Application in regards to users other than the one under whose command the Application is now running. Fact contribution: 0.25 if other users have engaged less than 2 times, 0.5 if other users have engaged less than 5 times, 0.75 if other users have engaged less than 10 times, and 1 if other users have engaged 10 times or more.
5. Has the Application Incarnation aggregated Posts for this Target Focus before? Fact contribution: 0 if no posts prior, 0.5 if 1 to 3 posts prior, 1 if 4 or more posts prior. The data for this fact is provided by the Application Server in the initial data set.
6. Is the Post recent? The core Boolean value for this fact is if the post was made within X months prior to the current date and time, where X is determined by a variable provided by the Application Server in the initial data set. Fact contribution is calculated as the number of days from X to the date of the Post divided by the number of days from X to the current date. Fact contribution here is allowed to become a negative value.
7. Are other people tagged or linked in to the Post either in any text content or other data provided with the Post from its Source? Fact contribution: 0.25 if 0 people, 0.5 if 1 to 10 people, 1 if more than 10 people.
9. Is the Post generally engaged with according to data provided from the Post's Source? Fact contribution: 0 if no engagement, 0.25 if engagement by 1 to 5 people, 0.5 if engagement by 6 to 15 people, and 1 if engagement by 16 or more people.
10. Is this post suitable for display on the device being used to run the current instance of the Application? Determined by display size, availability, and media type and size. Fact contribution: 1.
11. Does the post have key words in any text content, hashtags or other indicators that relate to trending topics that are also related to the Target Focus? Trending topics that relate to the Target Focus are provided by Application Server in initial data set. Fact contribution: 1.

Once the relevance factors for all posts have been determined, an array is created for each Focus/Page to be displayed, except where configuration data obtained in the initial data set indicates that a given Focus/Page is not to be displayed. All posts that meet or exceed the Focus Relevance Factor for the given focus are added to its array. Each array is then sorted by date of the post (using data received with the post), with the most recent posts coming first. Each post in each array is evaluated to determine if it should be displayed—i.e., if it will be visible to the End-User. This visibility defaults to True (or On) for each post. It is set to False if a post's Content Relevance is under the value provided by the Application Server for the purpose of the target focus. A post will also have its visibility set to False if it has a duplicate in the same focus, in which case the post to be turned off will be the one that has a source that does not match the target focus or the older of the two.

In preparation for displaying a given Focus/Page, an empty array is created for it. The matching Focus' array of available data is iterated through. The matching Focus item is added to the display array during each iteration. All other Focus arrays are then iterated through in an order determined by the Server configuration.

Each item in the other Focus arrays is evaluated for relevance to the item in the matching Focus array that is currently being iterated on. If it is relevant, it is added to the display array. An element of a Focus array is relevant to an element in the matching Focus array if A is met and any of the other criteria are met: (This must be met for the element to be relevant.) It is not a Share of one another. For example, social media accounts can be set to automatically share posts by the user's account on another social media network; these posts are not considered relevant as the embedded/shared content is a 100% match. Also, the post's creation date meta-data must fall within a threshold from the current date defined by Server configuration.

Keyword, hashtag, or other meta data matches such as geo-location tagging between the two elements, with a minimum number (1 or more) is provided by Server configuration.

There is a 30% or more text match on words between the two elements, where the text match is based on words that are not articles or prepositions or other words provided by Server configuration.

This process of iterating through the other Focus arrays and adding relevant posts to the current display array will be performed on all Focus arrays, except where limited by Server configuration. This is to optionally ignore a Focus entirely, and to include optional minimum and maximum elements from that Focus as determined by Server Configuration. The cross-Focus relevancy minimum and maximum numbers are adjusted on the Server over time based on: user engagement in the End-User application, user; engagement on third party networks; and, user-specific metrics.

The Main Page is a special case in that it may include a sample Post from each focus type. The Posts displayed on the Main Page do not impact the process described above. One of each type is displayed on the Main Page, in the same order that the Pages are displayed in the Menu, unless the Application Server provides data indicating otherwise. The Application Server may specify the order Posts are displayed based on focus type, and it may indicate that only a subset of focus types will be displayed. By default, the post for each focus type chosen will be the most recent post that matches the focus type in the data source of the post. In the initial data set, the Application Server may specify that the chosen post will be—instead of the most recent—the post with the highest focus relevancy, or content relevancy, where the data source matches the focus. The post that is most recent of the options will be selected in the event of multiple options.

The Data Aggregation Logic determines which pages to include in the Menu using the following logic: Home—always shows, always top of Menu order.

All other pages show if: this page is enabled by the Application's server and/or incarnation configuration flags, and if the total Page Priority score for the page is above 0 or a threshold provided by the Application's server or the incarnation's configuration and if the focus has at least one post assigned as the post's target focus.

Calculate Page Priority: To determine the Priority value of a Page, the Data Aggregation Logic begins with priority starting values assigned by the Application's server, examples listed below. The starting page priorities are given server-wide values in the Application's database. In a table storing values related to the Application incarnation's configuration, each page priority value can be defined and these values, if defined, are used instead of the server-wide values when the set of page priority starting values are given to the Application.

Server-Wide Page's Priority Starting Value:
1. Home: 10
2. Music: 90
3. Video: 90
4. Shows: 90
5. Messages 70
6. Images 80
7. Social 80
8. Sponsor: 10

Application Incarnation Page's Priority Starting Value:
2. Music: 10
6. Video: 0
7. Social 20

Each page's priority value is affected by values resulting from the aggregation of content. All the content is assessed and aggregated, and the content is given priority ratings. The content, as determined for each page, is then used to affect the total priority rating for the page. The logic for affecting the page's total priority is: Divide the Content Relevance factor for each post that has been assigned to the given Focus/page by 5, or a factor provided by the Application Server, or the Incarnation's Configuration, and the sum of these values is added to the Page's Priority value to create the Total Priority for the Focus/Page. For example, if the Video page had a starting Priority value of 0, and if there were 4 posts determined to be most appropriately displayed under the Video focus, and if the content relevance denominator is 5, and if each of the post's Content Relevance factor was 70, then we have: 0+(70/5)+(70/5)+(70/5)+(70/5)=56.

If an order is not specified in the initial data set provided by the application server, the pages are included in the menu in an order predetermined for the application incarnation by default. The Application Server can also specify that the pages are displayed in a sorted order: either ascending or descending based on the page's total priority value.

Data Storage—the logic and memory used to store data locally for the duration of a single or multiple operations of the application. Data is stored and retrieved by the Business Logic and the Data Communication logic.

Data that is stored for use in multiple operations of the application is stored on the device's local long term storage, as provided for by the device's Operating System, in an encrypted format. The data being stored includes:
Unique User Device ID—generated for the device if none is present when the application is initialized. Follows the generation algorithm as defined in Version 4 UUID standard definition (see https://en.wikipcdia.org/wiki/Universally unique-_identifier).
Unique System User ID—generated when the user's account is created by the server, a sequential user account integer value.
Session Key—generated by the server when the user's account is used within a period of time defined by the server, a string value.
User Name—string value provided by the user or acquired from other data results during normal operation of the application.
Application Status—string value indicating the state of the application installed on the device.

Data that is stored for use in a single operation of the application is stored in RAM as provided for by the device's Operating System. The data being stored includes:
Lists of all media and posts as defined by the Server, the Application code, and extra-network data sources such as Social Network API invocations. One list for each Focus type and for each media type and for each extra-network data source.
Application Incarnation configuration values as defined by the Application code.
User and account and application credentials, user account details.
Device metrics.
User use metrics.
Media such as the user's profile picture as defined and provided by a Social Network for the connected user's account, media used to display posts and data received during the session.

Data Communication—the logic used to send and receive data for use by the Business Logic and for possible short-term or long-term storage by the Data Storage logic. The Data Communication logic interacts with the network adapter provided by the platform on which the Application is operated.

The data communication consists of logic to send variables to the server scripts. The variables include session data, user account and metric data and commands indicating requests for specific types of data directly corresponding to the focus and media and social network types. Received data consists of all data returned by the server and extra-network interfaces and is passed along to the business logic for storage and utilization. This includes application state, user session information, user and device metrics.

The Data Communication logic interacts with the network interfaces and protocols provided by the Application's coding language and the device operating system that it is built for. The logic uses standard protocols for interacting with an HTTP interne server.

Asset Management is the logic set used by the Business Logic to retrieve, store, and manage audio, visual, and other types of media assets. Asset Management logic also handles art assets embedded in the Application for use in rendering the GUI. The logic encapsulates a queue of media load requests from other parts of the code, receiving variables indicating the internet URL and a reference to the function to be called when load is completed. The logic includes queue management methods such as checking the status of a loaded asset, adding and transmitting from the queue, and completion and error handling. The Asset Management logic—using loading and codec libraries provided by the programming language used to build the Application Incarnation—retrieves and stores all loaded assets, and makes them available the other parts of the code upon request ensuring that duplicate assets are not loaded and optimizing this process where possible. The media managed by the Asset Management logic includes, without limitation, MP3 and WAV audio formats, JPEG, GIF, BMP, PNG and other graphic formats.

Application Servers are the set of severs used by the system to run scripts, host data and media, and make these items accessible over the internet or other networks. The Application Servers use Application Databases and other Data Sources to store and retrieve data and media that is sent to the Application through the Network Adapter. The scripts include the following functionality: create account and session management, retrieve application settings, retrieve media and data configuration—for the Application Incarnation and the application's content both for the Application System and extra-network sources, email address validation, and profanity filtering. All System-determined variables, the Server Configuration, and data are stored in the Application Databases or retrieved directly from extra-network sources. All Server Configuration variables are set up with default values application wide. The Application Incarnation can override these variables. When the Application is loading the initial data set, the Server adjusts these variables based on user metrics and personal and demographic data. For example: a post's cross-Focus relevancy minimum and maximum values are adjusted depending on whether the user has been tracked to engage with these type of posts in the past. The amount and direction of the adjustments is based on settings maintained by the Application's Operator.

Application Databases are the set of databases and database tables used by the Application Servers for the purpose of data and media storage relating to incarnations of the Application.

Application Status Table has the Following Fields:
Row index of the table.
Application ID, which is the ID of the Application Incarnation, the same as the primary index of Application Configuration table used for this set of configurations.
Server Status, which is a state flag indicating the operation state of the incarnation's server-side component (scripts and database entries). 0=offline, 1=online.
Application status iOS, which is a state flag indicating the operation state of the end-user application for a specific platform. 0=offline, 1=online.
Application status Android, which is a state flag indicating the operation state of the end-user application for a specific platform. 0=offline, 1=online.
Application status Web, which is a state flag indicating the operation state of the end-user application for a specific platform. 0=offline, 1=online.
Application version iOS, which is a string indicating the most recently allowed version of the end-user application to allow establishing a use session for a specific platform.
Application version Android, which is a string indicating the most recently allowed version of the end-user application to allow establishing a use session for a specific platform.
Application version Web, which is a string indicating the most recently allowed version of the end-user application to allow establishing a use session for a specific platform.
Application key, which is a string containing a value used to identify valid end-user application communication with the server for the Application ID.

Application Configuration Table has the Following Fields:
Application ID, which is the primary index for this table, the unique identifier for the Application Incarnation's configuration throughout the System's data. The initial value begins at 1.
Display Name, which is a string value used in presentation logic by the end-user application.
Ad ID iOS, which is a string value used by the end-user application for display of ads on a specific platform.
Ad ID Android, which is a string value used by the end-user application for display of ads on a specific platform.
YouTube or Video ID, which is a string value used by the end-user application for display of video assets.
Instagram or Image ID, which is a string value used by the end-user application for display of image assets.
Twitter or Social ID, which is a string value used by the end-user application for display of text assets.
Facebook or Social Media ID, which is a string value used by the end-user application for display of media assets.
GUI Asset URL, which is a string value for graphic assets used in the presentation of the end-user application.

Sponsor Configuration Table has the Following Fields:
Row index of the table.
Application ID, which is the ID of the Application Incarnation, the same as the primary index of Application Configuration table used for this set of configurations.
Sponsor Asset Data, which is a string value containing configuration information for a sponsor asset, html snippet that may include text or graphic embedded asset URLs and other html display instructions.

The row with index 0 is reserved for default configuration information that may be overridden by a specific application incarnation's configuration.

Media Configuration Table has the Following Fields:
Row index of the table.
Application ID, which is the ID of the Application Incarnation, the same as the primary index of Application Configuration table used for this set of configurations.
YouTube or Video Configuration, which is a string value used by the end-user application containing configuration data for the display of video, including the number of assets to display.
Instagram or Image Configuration, which is a string value used by the end-user application containing configuration data for the display of images and image posts, including the number of assets to display and date information.
Twitter or Social Configuration, which is a string value used by the end-user application containing configuration data for the display of text assets and text-based posts, including the number of assets to display and date information.
Facebook or Social Media Configuration, which is a string value used by the end-user application containing configuration data for the display of social media assets and multi-media posts, including the number of assets to display, date information, and flags indicating treatment of post data.

The row with index 0 is reserved for default configuration information that may be overridden by a specific application incarnation's configuration.

Album Asset Configuration Table, which defines a collection of Audio Assets, has the following fields:
Row index of the table and Album ID.
Application ID, which is the ID of the Application Incarnation, the same as the primary index of Application Configuration table used for this set of configurations.
Display Order, which is the integer value determining display sequence of album assets for a given Incarnation.
Album Title, which is a string display value.
Album Image URL, which is a string value indicating an image associated with the album.
Album Link URL, which is a string value indicating extra-network link to album information or for purchase of album.

Audio Asset Configuration Table has the Following Fields:
Row index of the table and Asset ID.
Application ID, which is the ID of the Application Incarnation, the same as the primary index of Application Configuration table used for this set of configurations.
Album ID, which is the integer value indicating the album the asset belongs to, the same as the primary index of the Album Configuration table.
Display Order, which is the integer value determining display sequence of audio assets for a given Incarnation.
Asset Title, which is a string display value.
Asset Author, which is a string display value.
Asset URL, which is a string value indicating location and filename of asset.
Asset Image URL, which is a string value indicating an image associated with the asset.
Asset Link URL, which is a string value indicating extra-network link to asset information or for purchase of album.

Video Asset Configuration Table has the Following Fields:
Row index of the table and Asset ID.
Application ID, which is the ID of the Application Incarnation, the same as the primary index of Application Configuration table used for this set of configurations.
Display Order, which is the integer value determining display sequence of audio assets for a given Incarnation.
Asset Title, which is a string display value.
Asset URL, which is a string value indicating location and filename of asset or other identifier used in display of the video asset.

User Table has the Following Fields:
Row index of the table and User ID.
User Name, which is a string display value.
User Password, which is a string password value for user account. May not be required for user accounts that are tracked by device install.
User E-mail, which is a string value of e-mail address provided by the user.
UUID, which is a list of unique ID values generated by the End-user Application associated with this user account.
Instagram or Image ID, which is a string value of Instagram or Image Social Network user IDs associated with this user account.
Twitter or Social ID, which is a string value of Twitter or Social Network user IDs associated with this user account.
Facebook or Social Media ID, which is a string value of Facebook or Social Media Network user Ills associated with this user account.
Last Session Time, which is a time stamp for when the latest session using this account was begun.
Session Key, which is the session key generated for the latest session using this account.
Platforms, which is a list of platform identifiers that have been used to begin a session with this account.
Last Platform, which is the most recent platform identifier that was used to begin a session with this account.
Birth Date, which is the birth date given by the user of this account signifying the user's age.
Demographic Data, which is a string value containing demographic identifiers that can be associated with the user as determined by the System.

User Metrics Table has the Following Fields:
Row index of the table.
Application ID, which is the ID of the Application Incarnation, the same as the primary index of Application Configuration table used for this set of configurations.
User ID, which is the ID of the User account, the same as the primary index of the User table that this set of data is related to.
Device ID, which is a string identifier for the device these metrics were collected on.
Time Begun, which is a time stamp of the first time metrics were collected for this combination of user, application incarnation, and device.
Time Updated, which is a time stamp for the last time metrics were collect for this combination of user, application incarnation and device.
Metrics, which is a string value containing metrics information such as post types interacted with and Focus/pages viewed.

One row for each user on each device for each application ID.

High Level Use Flow—COPY
1. End User—Launch Application
2. Application GUI—Log In or Create Account
   a. Data Storage
   b. Data Communication
   c. Application Server—Handle Log In or Create Account
   d. Data Sources—Handle Log In
3. Business Logic—Load Initial Data
   a. Data Aggregation Logic—Settings and Aggregation Logic
   b. Data Storage
   c. Data Communication
   d. Application Server—Assemble Config. and Data
   e. Data Sources—Return Data Sets
4. Data Aggregation Logic—Process Data Set
   a. Data Storage
   b. Asset Management
   c. Application Server—Return Config., Media and Assets
   d. Data Sources—Return Media and Assets
   e. Asset Management—Asset Handling, Storage
5. Business Logic—Render Display
   a. Data Aggregation Logic—Determine Display
   b. Data Storage
   c. Application Server—Return Media and Assets
   d. Asset Management
   e. Data Sources—Return Media and Assets
   f. Application GUI—Display Media and Assets
6. End User—Interact with App GUI
   a. Business Logic—Respond to Interaction
   b. Data Communication
   c. Asset Management
   d. Data Sources—Return Media, Link Out
7. Business Logic—Collect User Metrics
   a. Data Storage
   b. Data Communication
   c. Application Server—Store Metrics
8. Business Logic—Request More Data
   a. Data Storage
   b. Data Communication
   c. Application Server—Store Metrics
   d. Asset Management
   e. Data Sources—Return Media, Assets
   f. Data Communication—Process and Store Data
9. Data Aggregation Logic—Process Data Set—loop to 4

1. A method of aggregating content, wherein the method comprises the steps of:
receiving, by one or more processors, a request to transmit primary content created by or related to one or more sources, wherein the primary content comprises one or more of the following content types—home content, music content, video content, show content, message content, image content, social content and sponsor content;
transmitting, by one or more processors, the requested primary content;
organizing the primary content into more than one page, and ordering individual content items in each page based on one or more first metric values determined from previously entered data by one or more processors, for display on a graphical user interface, each of the more than one pages is directed to a single content type;
presenting the organized and ordered primary content on the display of a graphical user interface for a non-transitory time;
determining a value for one or more second metrics associated with the organized and ordered primary content by one or more processors;
automatically transmitting, organizing and ordering, by the one or more processors, secondary content based on the value for one or more second metrics, for display on the graphical user interface, by one or more processors;
thereby aggregating the content.

2. A non-transitory computer-readable medium with instructions stored thereon, that when executed by a processor, perform the steps comprising:
receiving a request to transmit primary content created by or related to one or more sources, wherein the primary content comprises one or more of the following content types—home content, music content, video content, show content, message content, image content, social content and sponsor content;
transmitting the requested primary content;
organizing the primary content into more than one page, and ordering individual content items in each page based on one or more first metric values determined from previously entered data display on a graphical user interface, each of the more than one pages is directed to a single content type;
presenting the organized and ordered primary content on the display of a graphical user interface for a non-transitory time;
determining a value for one or more second metrics associated with the organized and ordered primary content;
automatically transmitting, organizing and ordering secondary content based on the value for one or more second metrics, for display on the graphical user interface.

3. A computer-implemented method for aggregating content and displaying the content in a graphical user interface, the method comprising the steps of:
displaying a first window in a graphical user interface comprising a dialog box that is capable of receiving a request to transmit primary content created by or related to one or more sources, wherein the primary content comprises one or more of the following content types—home content, music content, video content, show content, message content, image content, social content and sponsor content;
displaying a second window in the graphical user interface that presents the primary content in an organized fashion, wherein the content is organized based on one or more first metric values determined from previously entered data related to one or more user preferences;
determining a value for one or more second metrics associated with the organized and ordered primary content by one or more processors;
automatically transmitting, organizing and ordering, by the one or more processors, secondary content based on the value for one or more second metrics;
displaying a third window in the graphical user interface that presents the organized secondary content;
thereby aggregating and displaying the content on the graphical user interface.
